(19) United States
(12) Patent Application Publication
(10) Pub. No.: US 2025/0276561 A1
(43) Pub. Date: Sep. 4, 2025

(54) AUTOMOTIVE THERMAL MANAGEMENT FLUID MODULE

(71) Applicant: HANON SYSTEMS, Daejeon (KR)

(72) Inventor: In Keun KANG, Daejeon (KR)

(21) Appl. No.: 18/858,561

(22) PCT Filed: Sep. 13, 2023
(86) PCT No.: PCT/KR2023/013728

§ 371 Date: Oct. 21, 2024

(30) Foreign Application Priority Data
Dec. 8, 2022 (KR) 10-2022-0170502

(51) Int. Cl. B60H 1/32; F28D 21/00

(52) U.S. Cl. CPC B60H 1/3229; F28D 21/00; B60H 2001/325; B60H 2001/3257; F28D 2021/0082

(57) ABSTRACT

One embodiment relates to an automotive thermal management fluid module using a circulating fluid, such as a refrigerant or coolant, the module comprising: a manifold plate having a plurality of fluid passages formed therein; and a thermal interference avoidance unit that is coupled to the manifold plate, wherein fluid passages having a relatively high or low temperature from among the fluid passages are formed separately other fluid passages.

### TECHNICAL FIELD

The present invention relates to an automotive thermal management fluid module, and more specifically, to an automotive thermal management fluid module that modularizes a heat exchanger and valve components into one.

### BACKGROUND ART

Under the trend of environmentally friendly industrial development and development of energy sources that replace fossil fuels, the most notable fields in the automobile industry recently are electric vehicles and hybrid electric vehicles. An electric vehicle and a hybrid electric vehicle are provided with a battery to provide a driving force, and the battery is used not only for traveling but also for cooling and heating.

In vehicles that provide the driving force using the battery, when the battery is used as a heat source for cooling and heating, it means that a traveling distance is reduced accordingly, and to overcome the above problem, methods of applying a thermal management system widely used in household heating and cooling devices to vehicles have been proposed.

For reference, the thermal management system refers to absorbing low-temperature heat and transferring the absorbed heat to high temperature. As an example, the thermal management system has a cycle in which a liquid fluid evaporates in an evaporator, takes heat from the surroundings to become a gas, and then discharges heat back to the surroundings by a condenser to be liquefied. When the thermal management system is applied to electric vehicles or hybrid electric vehicles, there is an advantage that it is possible to secure a heat source that is lack in conventional general air conditioners.

Currently, a modularization configuration of the thermal management system for an electric vehicle is a partial modularization method, and important parts (a valve, an accumulator, a chiller, a condenser, an internal heat exchanger, a sensor, etc.) are connected by pipes. In the process of modularizing the thermal management system for a vehicle, there is a problem that thermal management performance is degraded due to thermal interference between a high-temperature fluid and a low-temperature fluid.

### DISCLOSURE

### Technical Problem

One embodiment of the present invention is directed to providing an automotive management fluid module having a structure that can minimize thermal interference between a high-temperature fluid and a low-temperature fluid by arranging inlets and outlets of a heat exchanger through which a high-temperature fluid flows and a heat exchanger through which a low-temperature fluid flows to be maximally spaced apart, thereby preventing degradation of thermal management performance.

In addition, one embodiment of the present invention is directed to providing an automotive management fluid module having a structure that can minimize pressure loss so that a flow path through which a low-temperature and low-pressure fluid flows has a greater flow cross-sectional area than another flow path in a cooling mode.

In addition, one embodiment of the present invention is directed to providing an automotive management fluid module having a structure that can accurately sense a state of a fluid discharged from a chiller by arranging a PT sensor for measuring a temperature and pressure of the fluid (refrigerant) on a flow path at an outlet side of the chiller (second heat exchanger) among heat exchangers.

### Technical Solution

An automotive thermal management fluid module according to one embodiment of the present invention may include a manifold plate having a flow path through which refrigerant flows formed therein, and a heat exchanger which is coupled to one surface of the manifold plate, in which the refrigerant and coolant exchange heat while flowing, and which has a refrigerant inlet and a refrigerant outlet through which the refrigerant is introduced and discharged, and the refrigerant inlet and the refrigerant outlet of the heat exchanger are disposed at one end or the other end of the manifold plate, and the refrigerant inlet is disposed above the refrigerant outlet.

The heat exchanger may include a first heat exchanger which is coupled to one surface of the manifold plate, in which high-temperature refrigerant and coolant exchange heat while flowing, and which is provided with a first refrigerant inlet and a first refrigerant outlet through which the high-temperature refrigerant is introduced and discharged, and a second heat exchanger which is coupled to one surface of the manifold plate, in which low-temperature refrigerant and coolant exchange heat while flowing, and which is provided with a second refrigerant inlet and a second refrigerant outlet through which the refrigerant is introduced and discharged, and the first refrigerant inlet and the first refrigerant outlet may be disposed to be spaced apart from the second refrigerant inlet and the second refrigerant outlet.

The first refrigerant inlet and the first refrigerant outlet may be disposed at one end of the manifold plate, and the second refrigerant inlet and the second refrigerant outlet may be disposed at the other end of the manifold plate.

The first heat exchanger may be provided with a first coolant inlet and a first coolant outlet through which the coolant is introduced and discharged, and the second heat exchanger may be provided with a second coolant inlet and a second coolant outlet through which the coolant is introduced and discharged.

The first coolant inlet and the first coolant outlet may be disposed adjacent to the second coolant inlet and the second coolant outlet.

The first coolant inlet and the first coolant outlet, and the second coolant inlet and the second coolant outlet may be disposed between the first refrigerant inlet and the first refrigerant outlet, and the second refrigerant inlet and the second refrigerant outlet.

A distance between the first coolant inlet and the first coolant outlet, and the second coolant inlet and the second coolant outlet may be greater than a distance between the first refrigerant inlet and the first refrigerant outlet, and the second refrigerant inlet and the second refrigerant outlet.

The manifold plate at the locations at which the first coolant inlet, the first coolant outlet, the second coolant inlet, and the second coolant outlet are disposed may be formed to be open.

A flow path through which the refrigerant flows into the second heat exchanger and a flow path through which refrigerant discharged from the second heat exchanger may have a large flow cross-sectional area than other flow paths.

A sensor configured to measure a temperature and pressure of the refrigerant may be disposed on a flow path through which refrigerant discharged from the refrigerant outlet flows.

An inlet hole of the refrigerant inlet, an outlet hole of the refrigerant outlet, and a sensor insertion hole into which the sensor is inserted, which are formed in the manifold plate, may be disposed in a direction of gravity.

The sensor may be coupled to the same one surface of the manifold plate as the heat exchanger.

The heat exchanger may be coupled to the one surface of the manifold plate, and the sensor may be coupled to a side surface of the manifold plate.

The first heat exchanger may be a water-cooled condenser, and the second heat exchanger may be a chiller.

### Advantageous Effects

According to one embodiment of the present invention, it is possible to minimize the thermal interference between the high-temperature fluid and the low-temperature fluid by arranging the inlets and outlets of the heat exchanger through which the high-temperature fluid flows and the heat exchanger through which the low-temperature fluid flows to be maximally spaced apart, thereby preventing degradation of thermal management performance.

In addition, according to one embodiment of the present invention, it is possible to minimize pressure loss so that the flow path through which the low-temperature and low-pressure fluid flows has a greater flow cross-sectional area than another flow path in the cooling mode.

In addition, according to one embodiment of the present invention, it is possible to accurately sense the state of the fluid discharged from the chiller by arranging the sensor for measuring the temperature and pressure of the fluid (refrigerant) on the flow path at the outlet side of the chiller (second heat exchanger) among the heat exchangers.

### DESCRIPTION OF DRAWINGS

FIG. 1 is a perspective view showing a front surface of an automotive thermal management fluid module according to one embodiment of the present invention.

FIG. 2 is a view showing a rear surface of the automotive thermal management fluid module according to one embodiment of the present invention.

FIG. 3 is a view showing a high-temperature flow path and a low-temperature flow path of the automotive thermal management fluid module according to one embodiment of the present invention.

FIG. 4 is a view showing that a sensor of the automotive thermal management fluid module according to one embodiment of the present invention is installed on a manifold plate.

FIG. 5 is a view showing another installation example of the sensor shown in FIG. 4.

### MODE FOR INVENTION

Since the present invention may have various changes and various embodiments, specific embodiments are shown in the accompanying drawings and described in detail. However, it should be understood that it is not intended to limit specific embodiments and includes all modifications, equivalents, and substitutes included in the spirit and technical scope of the present invention. In describing the present invention, when it is determined that the detailed description of a related known technology may unnecessarily obscure the gist of the present invention, detailed description thereof will be omitted.

Terms such as first and second may be used to describe various components, but the components should not be limited by the terms. The terms are used only for the purpose of distinguishing one component from another.

The terms used in the present application are only used to describe specific embodiments and are not intended to limit the present invention. The singular includes the plural unless the context clearly dictates otherwise. In the application, it should be understood that terms such as “comprise” or “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

In addition, throughout the specification, when a certain component is described as being “connected” to another, this does not just mean that two or more components are directly connected and may mean that two or more components are indirectly connected through another component, are physically connected, and electrically connected, or are referred to as different names depending on positions or functions thereof but are integrated.

Hereinafter, one embodiment of an automotive thermal management fluid module according to the present invention will be described in detail with reference to the accompanying drawings, and in describing the present invention with reference to the accompanying drawings, the same or corresponding components are denoted by the same reference numeral, and overlapping descriptions thereof will be omitted.

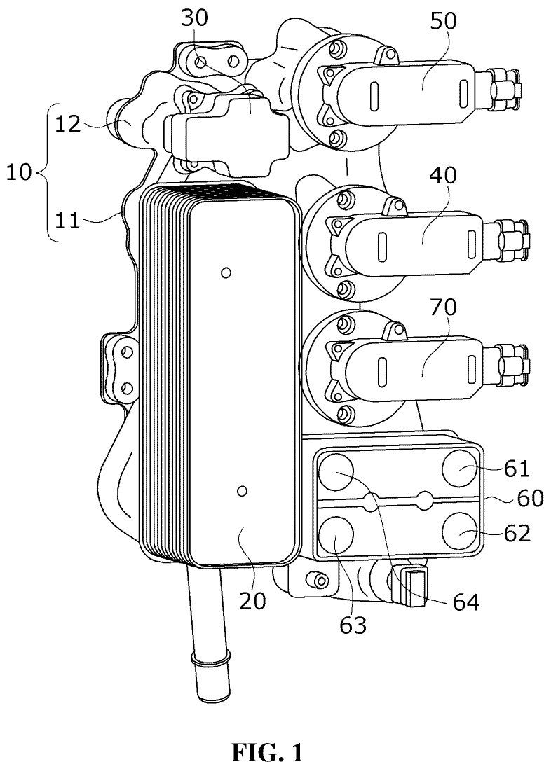

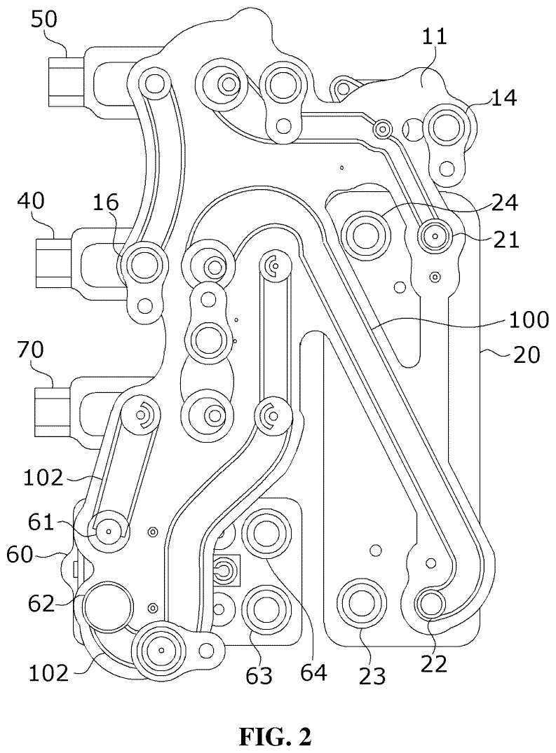

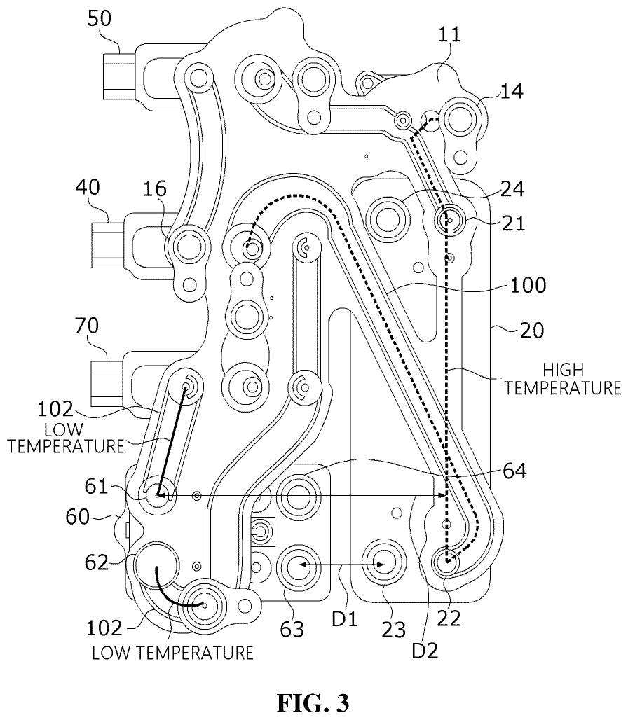

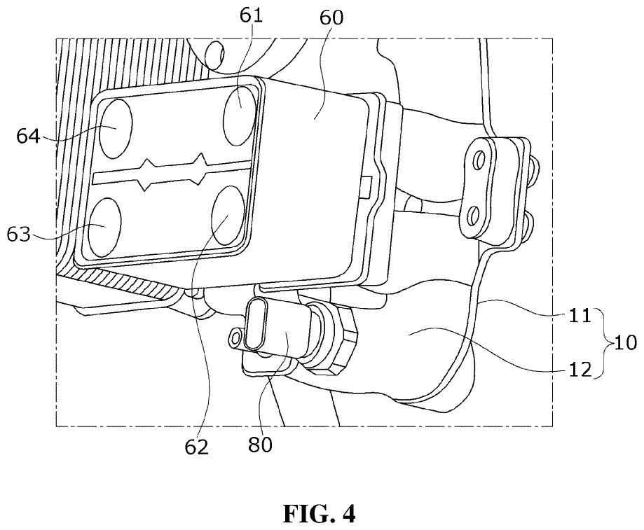

FIG. 1 is a perspective view showing a front surface of an automotive thermal management fluid module according to one embodiment of the present invention, FIG. 2 is a view showing a rear surface of the automotive thermal management fluid module according to one embodiment of the present invention, FIG. 3 is a view showing a high-temperature flow path and a low-temperature flow path of the automotive thermal management fluid module according to one embodiment of the present invention, and FIG. 4 is a view showing that a sensor of the automotive thermal management fluid module according to one embodiment of the present invention is installed on a manifold plate.

Therefore, as shown, the automotive thermal management fluid module according to one embodiment of the present invention may include a manifold plate 10 having a flow path through which refrigerant flows formed therein, and heat exchangers 20 and 60 which are coupled to one surface of the manifold plate 10, in which the refrigerant and coolant exchange heat while flowing, and which have refrigerant inlets 21 and 61 and refrigerant outlets 22 and 62 through which the refrigerant is introduced and discharged, in which the refrigerant inlets 21 and 61 and the refrigerant outlets 22 and 62 of the heat exchangers 20 and 60 may be disposed at an end of one side or the other side of the manifold plate 10, and the refrigerant inlets 21 and 61 may be disposed above the refrigerant outlets 22 and 62.

The manifold plate 10 has a substantially plate shape that has a fluid path formed therein and has a predetermined thickness. As described above, the manifold plate 10 may be modularized by coupling a first heat exchanger 20 and a second heat exchanger 60 that are heat exchange devices of the thermal management system, expansion valves 30 and 70, and direction change valves 40 and 50, thereby reducing the number of processes for manufacturing a product and reduce the number of processes in an assembly line of a vehicle. In addition, the manifold plate 10 may perform functions of piping, fitting, and housing at the same time, thereby saving cost and improving workability.

The manifold plate 10 may include an assembly composed of a bottom plate 11 and a top plate 12 and may be manufactured in a coupling manner using brazing, structural adhesives, gaskets, etc. In addition, a material of the manifold plate 10 may be applied variously according to a manufacturing method or purposes and functions, such as aluminum, thermoplastic, and stainless steel.

The bottom plate 11 is formed in a plate shape, and the top plate 12 is coupled to protrude a predetermined thickness from one surface of the bottom plate 11, thereby forming a fluid flow path between the bottom plate 11 and the top plate 12.

Referring to FIG. 2, a fluid introduction port 14 through which a high-temperature and high-pressure gaseous fluid discharged from a compressor or an internal condenser is provided on a rear surface of the manifold plate 10. In addition, various fluid ports for the introduction and discharge of the fluid may be provided on the rear surface of the manifold plate 10. In the present embodiment, an external heat exchanger discharge port 16 through which refrigerant is discharged to an external heat exchanger (not shown) is provided.

Referring back to FIG. 1, the manifold plate 10 is coupled to the first heat exchanger 20 and the second heat exchanger 60 as heat exchange devices. The refrigerant and the coolant may exchange heat while passing through the first heat exchanger 20 and the second heat exchanger 60, respectively.

In the present embodiment, a water-cooled condenser may be used as the first heat exchanger 20, and a chiller may be used as the second heat exchanger 60. The water-cooled condenser serves to condense a high-temperature and high-pressure gaseous fluid (refrigerant) discharged from the compressor or the internal condenser into a high-pressure liquid by exchanging heat with an external heat source. The chiller is a device in which a low-temperature and low-pressure fluid is supplied and exchanges heat with coolant flowing in a coolant circulation line (not shown), and the cold coolant exchanging heat in the chiller may exchange heat with a battery by circulating in the coolant circulation line.

The first heat exchanger 20 is provided with a refrigerant port through which refrigerant is introduced and discharged. The refrigerant port includes a first refrigerant inlet 21 and a first refrigerant outlet 22 provided at an upper end and lower end of the first heat exchanger 20, respectively. The first refrigerant inlet 21 is a part through which the refrigerant passing through the first expansion valve 30 is introduced, and the first refrigerant outlet 22 is a part through which the refrigerant exchanging heat in the first heat exchanger 20 is discharged. The first refrigerant inlet 21 and the first refrigerant outlet 22 may be formed in the form of a hole at the upper and lower ends of the first heat exchanger 20, respectively.

In this case, considering thermal interference, the first refrigerant inlet 21 may be formed at one side close to the first expansion valve 30, and the first refrigerant outlet 22 may be formed at the other side far from the first expansion valve 30. More specifically, the first refrigerant inlet 21 may be disposed closer to the first expansion valve 30 than the first refrigerant outlet 22 is. For example, a distance from the first expansion valve 30 to the first refrigerant inlet 21 may be smaller than a distance from the first expansion valve 30 to the first refrigerant outlet 22.

In addition, the first heat exchanger 20 is provided with a coolant port through which coolant is introduced and discharged. The coolant port includes a first coolant inlet 23 and a first coolant outlet 24 provided at the lower end and upper end of the first heat exchanger 20, respectively. The first coolant inlet 23 is a part through which coolant is introduced, and the first coolant outlet 24 is a part through which coolant exchanging heat with the refrigerant is discharged. The coolant exchanges heat with the refrigerant while flowing in a direction (bottom→top) opposite to the refrigerant.

Since the above-described refrigerant port and coolant port are disposed separately, it is possible to improve the assemblability of refrigerant pipes and coolant pipes.

The first expansion valve 30 serves to control whether to expand the refrigerant flowing into the first heat exchanger 20. The first expansion valve 30 may be disposed above the first heat exchanger 20 and may expand or pass the refrigerant introduced through the fluid introduction port 14. The refrigerant introduced through the first expansion valve 30 may exchange heat while passing through the first heat exchanger 20 or move to an external heat exchanger.

The refrigerant discharged through the first refrigerant outlet 22 of the first heat exchanger 20 flows into the first direction change valve 40. The first direction change valve 40 serves to control a direction of the refrigerant discharged from the first heat exchanger 20. The refrigerant flowing into the first direction change valve 40 may move to the external heat exchanger. In this case, the refrigerant may move to the external heat exchanger through the external heat exchanger discharge port 16. In addition, the refrigerant flowing into the first expansion valve 30 may move to the second direction change valve 50 and then to an evaporator (not shown) in a dehumidification mode.

The second heat exchanger 60 receives the low-temperature and low-pressure refrigerant and exchanges heat with the coolant moving from the coolant circulation line (not shown). The cold coolant exchanging heat in the second heat exchanger 60 may exchange heat with the battery by circulating in the coolant circulation line. The refrigerant exchanging heat with the external heat exchanger flows into the second expansion valve 70, and the refrigerant expanded in the second expansion valve 70 flows into the second heat exchanger 60. The refrigerant exchanging heat in the second heat exchanger 60 is discharged through the lower end thereof and flows into an accumulator (not shown).

To this end, the second heat exchanger 60 is provided with a refrigerant port through which refrigerant is introduced and discharged. The refrigerant port includes a second refrigerant inlet 61 and a second refrigerant outlet 62 provided at an upper end and lower end of the second heat exchanger 60, respectively. The second refrigerant inlet 61 is a part through which the refrigerant is introduced, and the second refrigerant outlet 62 is a part through which the refrigerant exchanging heat in the second heat exchanger 60 is discharged. The second refrigerant inlet 61 and the second refrigerant outlet 62 may be formed in the form of a hole at the upper and lower ends of the second heat exchanger 60, respectively.

In this case, considering thermal interference, the second refrigerant inlet 61 of the second heat exchanger 60 may be formed at one side close to the second expansion valve 70, and the second refrigerant outlet 62 may be formed at the other side far from the second expansion valve 70. More specifically, the second refrigerant inlet 61 may be disposed closer to the second expansion valve 70 than the second refrigerant outlet 62 is. For example, a distance from the second expansion valve 70 to the second refrigerant inlet 61 may be smaller than a distance from the second expansion valve 70 to the second refrigerant outlet 62.

Among the fluid flow paths formed on the manifold plate 10 in FIG. 3, a path marked by the dotted line may be a relatively high-temperature or low-temperature fluid flow path. A flow path through which the refrigerant discharged after exchanging heat in the first heat exchanger 20 flows into the first direction change valve 40 may be a high-temperature flow path 100, and a flow path through which the refrigerant flows into the second heat exchanger 60 and a flow path through which the refrigerant exchanging heat in the second heat exchanger 60 is discharged may be a low-temperature flow path 102.

Since the high-temperature flow path 100 and the low-temperature flow path 102 are fluid flow paths formed in one manifold plate 10, when disposed adjacent to each other, thermal management performance may be degraded due to thermal interference therebetween. Therefore, in the present embodiment, to arrange the high-temperature flow path 100 and the low-temperature flow path 102 to be spaced apart, the refrigerant inlets 21 and 61 and the refrigerant outlets 22 and 62 of the first heat exchanger 20 and the second heat exchanger 60 are disposed to be maximally spaced apart.

More specifically, the refrigerant inlets 21 and 61 and the refrigerant outlets 22 and 62 are discharged in the first heat exchanger 20 and the second heat exchanger 60, respectively, for heat exchange of refrigerant and disposed at locations as far away as possible to minimize thermal interference between the respective refrigerants flowing therethrough. As an example, the first refrigerant inlet 21 and the first refrigerant outlet 22 may be disposed at one end, that is, a right end of the manifold plate 10, and the second refrigerant inlet 61 and the second refrigerant outlet 62 may be disposed at the other end, that is, a left end of the manifold plate 10, thereby minimizing thermal interference.

In addition, the refrigerant inlets 21 and 61 may be disposed above the refrigerant outlets 22 and 62 so that the refrigerant may flow in a direction of gravity, that is, from the top to the bottom.

Meanwhile, the first heat exchanger 20 and the second heat exchanger 60 have a first coolant inlet 23 and a first coolant outlet 24, and a second coolant inlet 63 and a second coolant outlet 64, respectively, and the first coolant inlet 23 and the first coolant outlet 24, and the second coolant inlet 63 and the second coolant outlet 64 may be disposed between the first refrigerant inlet 21 and the first refrigerant outlet 22, and the second refrigerant inlet 61 and the second refrigerant outlet 62. That is, as shown in the drawing, from the left, the second refrigerant inlet 61, the second refrigerant outlet 62, the second coolant inlet 63, the second coolant outlet 64, the first coolant inlet 23, the first coolant outlet 24, the first refrigerant inlet 21, the first refrigerant outlet 22 may be disposed sequentially.

In the first heat exchanger 20 and the second heat exchanger 60, the refrigerant flows along the fluid flow path formed in the manifold plate 10, but the coolant flows through a separate pipe and thus is relatively unaffected by thermal interference. Therefore, the above pipe is configured to be disposed between the refrigerant inlets 21 and 61 and the refrigerant outlets 22 and 62 to minimize thermal interference.

The manifold plate 10 at the locations at which the first coolant inlet 23, the first coolant outlet 24, the second coolant inlet 63, and the second coolant outlet 64 are disposed may be formed to be open to be connected to the pipe (not shown). That is, the first heat exchanger 20 and the second heat exchanger 60 may be coupled to a front surface of the manifold plate 10, and the first coolant inlet 23 and the first coolant outlet 24, and the second coolant inlet 63 and the second coolant outlet 64 may be provided on rear surfaces of the first heat exchanger 20 and the second heat exchanger 60, respectively, and to avoid interference with the pipe connected at the rear of the manifold plate 10, the manifold plate 10 may be formed to be open.

In addition, a distance D1 between the first coolant inlet 23 and the first coolant outlet 24, and the second coolant inlet 63 and the second coolant outlet 64 may be greater than a distance D2 between the first refrigerant inlet 21 and the first refrigerant outlet 22, and the second refrigerant inlet 61 and the second refrigerant outlet 62. As described above, when the flow paths with a difference in fluid temperature is disposed to be spaced apart, it is possible to minimize thermal interference therebetween, thereby maximizing thermal management performance.

Meanwhile, the low-temperature flow path 102 through which the refrigerant flows into the second heat exchanger 60 and the low-temperature flow path 102 through which the refrigerant discharged from the second heat exchanger 60 flows may have a larger flow cross-sectional area than other flow paths (e.g., the high-temperature flow path 100). This is intended to minimum low-pressure side pressure loss in the low-temperature flow path 102 by constituting the relatively low-temperature and low-pressure refrigerant, which has a relatively large flow cross-sectional area, because the above refrigerant is sensitive to flow resistance such as the size of the cross-sectional area.

Referring to FIG. 4, a sensor 80 for measuring a temperature and pressure of the refrigerant may be disposed on the low-temperature flow path 102 through which the refrigerant discharged from the second heat exchanger 60 flows. This is intended to sense an accurate state (temperature, pressure) of the refrigerant discharged from the second heat exchanger 60 and improve the controllability of a chiller expansion valve (not shown).

The sensor 80 may be mounted on the top plate 12 of the manifold plate 10, that is, on the same one surface as the second heat exchanger 60 to sense a refrigerant state.

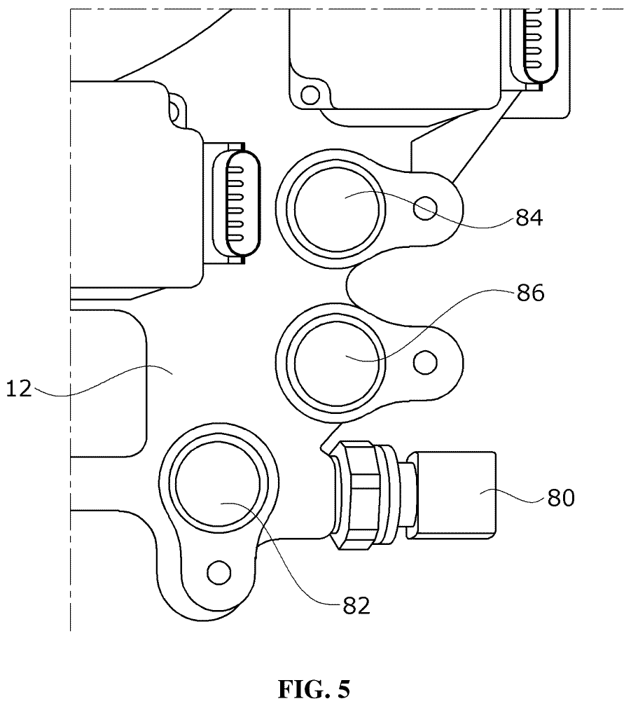

FIG. 5 is a view showing another installation example of the sensor shown in FIG. 4.

Referring to FIG. 5, the second heat exchanger 60 may be coupled to the one surface of the manifold plate 10, and the sensor 80 may be coupled to a side surface of the manifold plate 10. That is, in the above-described embodiment, the sensor 80 has been described as being coupled to the same one surface as the second heat exchanger 60, but as in the present embodiment, may also be coupled to a different one surface from the second heat exchanger 60.

In addition, an inlet hole 84 of the second refrigerant inlet 61, an outlet hole 86 of the second refrigerant outlet 62, and a sensor insertion hole 82 into which the sensor 80 is inserted, which are formed in the manifold plate 10, may be disposed in the direction of gravity. The inlet hole 84 and the outlet hole 86 are parts formed on the second refrigerant inlet 61 and the second refrigerant outlet 62, and the sensor insertion hole 82 is a part formed on the manifold plate 10 to couple the sensor 80.

In this drawing, although the inlet hole 84 and the outlet hole 86 are not formed to overlap the sensor 80 in a vertical direction, the inlet hole 84 and the outlet hole 86 may be formed to overlap the sensor 80 in the vertical direction.

Although the above description has been made with reference to specific embodiments of the present invention, those skilled in the art will be able to understand that the present invention may be variously modified and changed without departing from the spirit and scope of the present invention described in the appended claims.

[DESCRIPTION OF REFERENCE NUMERALS]

| | |
|---|---|
| 10: manifold plate | 11: bottom plate |
| 12: top plate | 14: fluid introduction port |
| 16: external heat exchanger discharge | 20: first heat exchanger |
| port | |
| 21: first refrigerant inlet | 22: first refrigerant outlet |
| 23: first coolant inlet | 24: first coolant outlet |
| 30: first expansion valve | 40: first direction change valve |
| 50: second direction change valve | 60: second heat exchanger |
| 61: second refrigerant inlet | 62: second refrigerant outlet |
| 63: second coolant inlet | 64: second coolant outlet |
| 70: second expansion valve | 80: sensor |
| 82: sensor insertion hole | 84: inlet hole |
| 86: outlet hole | 100: high-temperature flow path |
| 102: low-temperature flow path | |

1. An automotive thermal management fluid module comprising:
a manifold plate having a flow path through which refrigerant flows formed therein; and
a heat exchanger which is coupled to one surface of the manifold plate, in which the refrigerant and coolant exchange heat while flowing, and which has a refrigerant inlet and a refrigerant outlet through which the refrigerant is introduced and discharged, and
the refrigerant inlet and the refrigerant outlet of the heat exchanger are disposed at one end or the other end of the manifold plate, and the refrigerant inlet is disposed above the refrigerant outlet.

2. The automotive thermal management fluid module of claim 1, wherein the heat exchanger includes:
a first heat exchanger which is coupled to one surface of the manifold plate, in which high-temperature refrigerant and coolant exchange heat while flowing, and which is provided with a first refrigerant inlet and a first refrigerant outlet through which the high-temperature refrigerant is introduced and discharged; and
a second heat exchanger which is coupled to one surface of the manifold plate, in which low-temperature refrigerant and coolant exchange heat while flowing, and which is provided with a second refrigerant inlet and a second refrigerant outlet through which the refrigerant is introduced and discharged, and
the first refrigerant inlet and the first refrigerant outlet are disposed to be spaced apart from the second refrigerant inlet and the second refrigerant outlet.

3. The automotive thermal management fluid module of claim 2, wherein the first refrigerant inlet and the first refrigerant outlet are disposed at one end of the manifold plate, and the second refrigerant inlet and the second refrigerant outlet are disposed at the other end of the manifold plate.

4. The automotive thermal management fluid module of claim 2, wherein the first heat exchanger is provided with a first coolant inlet and a first coolant outlet through which the coolant is introduced and discharged, and the second heat exchanger is provided with a second coolant inlet and a second coolant outlet through which the coolant is introduced and discharged.

5. The automotive thermal management fluid module of claim 4, wherein the first coolant inlet and the first coolant outlet are disposed adjacent to the second coolant inlet and the second coolant outlet.

6. The automotive thermal management fluid module of claim 4, wherein the first coolant inlet and the first coolant outlet, and the second coolant inlet and the second coolant outlet are disposed between the first refrigerant inlet and the first refrigerant outlet, and the second refrigerant inlet and the second refrigerant outlet.

7. The automotive thermal management fluid module of claim 4, wherein a distance between the first coolant inlet and the first coolant outlet, and the second coolant inlet and the second coolant outlet is greater than a distance between the first refrigerant inlet and the first refrigerant outlet, and the second refrigerant inlet and the second refrigerant outlet.

8. The automotive thermal management fluid module of claim 4, wherein the manifold plate at the locations at which the first coolant inlet, the first coolant outlet, the second coolant inlet, and the second coolant outlet are disposed is formed to be open.

9. The automotive thermal management fluid module of claim 2, wherein a flow path through which the refrigerant flows into the second heat exchanger and a flow path through which refrigerant discharged from the second heat exchanger have a large flow cross-sectional area than other flow paths.

10. The automotive thermal management fluid module of claim 1, wherein a sensor configured to measure a temperature and pressure of the refrigerant is disposed on a flow path through which refrigerant discharged from the refrigerant outlet flows.

11. The automotive thermal management fluid module of claim 10, wherein an inlet hole of the refrigerant inlet, an outlet hole of the refrigerant outlet, and a sensor insertion hole into which the sensor is inserted, which are formed in the manifold plate, are disposed in a direction of gravity.

12. The automotive thermal management fluid module of claim 10, wherein the sensor is coupled to the same one surface of the manifold plate as the heat exchanger.

13. The automotive thermal management fluid module of claim 10, wherein the heat exchanger is coupled to the one surface of the manifold plate, and the sensor is coupled to a side surface of the manifold plate.

14. The automotive thermal management fluid module of claim 2, wherein the first heat exchanger is a water-cooled condenser, and the second heat exchanger is a chiller.
